(19) United States
(12) Patent Application Publication
(10) Pub. No.: US 2021/0354849 A1
(43) Pub. Date: Nov. 18, 2021

(54) Aircraft Detection

(71) Applicant: NVS Technology Solutions Ltd, Dubai (AE)

(72) Inventors: Safwan Kuzbari, Dubai (AE); Jamaleddine Nassar, Dubai (AE); Peter Wenham, Dubai (AE)

(21) Appl. No.: 16/972,713

(22) PCT Filed: Jun. 5, 2019
(86) PCT No.: PCT/EP2019/064687

§ 371 Date: Dec. 7, 2020

(30) Foreign Application Priority Data
Jun. 8, 2018 (GB) 1809478.9
Oct. 18, 2018 (GB) 1816995.3

(51) Int. Cl. B64D 45/00; G06F 1/3296

(52) U.S. Cl. CPC B64D 45/0063; B64D 2045/0085; G06F 1/3296

(57) ABSTRACT

Method and apparatus for detecting an operational state of an aircraft comprising conducting passive measurements including measuring an electromagnetic frequency at a location. Measuring a magnetic flux density at the location. Determining that the aircraft is in a powered state when criteria are met, wherein the criteria include the measured electromagnetic frequency is between 370 Hz and 1 kHz and the measured magnetic flux density is between 9 nT and 9200 nT.

### FIELD OF THE INVENTION

The present invention relates to a system and method for detecting aircraft and in particular, for detecting a powered state of an aircraft so that a device can be placed automatically in a flight-safe mode.

### BACKGROUND OF THE INVENTION

Electronic equipment taken onto an aircraft can adversely affect the systems within that aircraft. For example, there is a risk that transmitters found in mobile telephones and other wireless devices can interfere with navigation and communications equipment installed and in operation within an aircraft. Furthermore, certain types of cargo tracking devices (e.g. such as those described in WO 2017/187208) cannot be activated when they are within an aircraft that is operational. This can be difficult to achieve reliably. Additionally, passengers may forget or may even be unwilling to place their personal mobile devices into flight-safe mode within the aircraft. Therefore, there is required apparatus and method that can detect the operational status from within an aircraft and also such a device should be low-powered so that it can be operational for extended periods without external power.

U.S. Pat. No. 9,775,095 describes an aircraft proximity sensor system that includes a control module in communication with a transceiver module and an aircraft proximity sensor module, the control module to disable transmission by the transceiver module in response to the aircraft proximity sensor module. The aircraft proximity sensor module includes a tri-axis electromagnetic field sensor operable to detect electromagnetic fields generated by an aircraft. However, this system can have difficulty in discriminating between an aircraft and another source of electromagnetic frequencies.

Therefore, there is required a method and system that overcomes these problems.

### SUMMARY OF THE INVENTION

It has been determined that certain specific conditions or criteria can be detected that when met, indicate that an aircraft is in an operational state. For example, this can mean that its engines are running. In particular, when an aircraft is operational then electrical power is distributed throughout the aircraft, which generates a distinctive electromagnetic field. In particular, most if not all commercial aircraft generate an alternating current for use by electrical systems both internal and external to the aircraft system and this electrical supply operates at a frequency of between 370 Hz and 1 kHz. Many aircraft have a specific alternating current frequency of 400 Hz although some aircraft operate at specific other frequencies such as 800 Hz, for example. On its own, detecting such a specific frequency may erroneously indicate the operational state of an aircraft as other electrical systems may generate such a frequency or frequency range. Therefore, a further determination is made as to the magnetic flux density at this frequency. Specifically, if the magnetic flux density is between 9 nT and 9200 nT (or at least above 9 nT), then this confirms that the measurements are taking place at a location within an operational aircraft. Conversely, if either or both tests or criteria are not met then either the measurement device is not within an operational aircraft or it is within an aircraft but that aircraft is not in an operational or powered state (e.g. the engines are not running).

Such measurements may be achieved using a receiving coil or tuned circuit comprising an indictor and capacitor tuned to the particular frequency range. Optionally, a bandpass filter may be used to remove other frequencies and the resultant signal can be amplified and tested for its amplitude. The same receiver or sensor may be used to detect both frequency and amplitude, in some example implementations.

Whilst the two particular criteria provide a high confirmation level of the operational state of an aircraft, additional test or criteria may be used either in addition or as a confirmatory test. For example, in an operational state, a commercial aircraft used for passengers and/or freight will operate an internal pressurised environment. The internal atmosphere may undergo several distinct stages from the time that the passenger or cargo doors are open to those doors closing. Similarly, particular pressure changes may occur just before and after the doors are opened after landing, for example. Typically after the doors close then the interior of the aircraft acts as a pressure vessel controlled by various valves and compressors.

Therefore, as well as the electromagnetic frequency and magnetic flux density sensing a further criteria of detecting a pressure change event may be used to determine the operational state of the aircraft.

For example, valves to the atmosphere may be partially or wholly closed when the engines start and a small increase in pressure is applied before the aircraft moves. This momentary pressure increase may be equivalent to a drop in altitude of between 60 and 100 metres, which corresponds to an increase in pressure of between 780 Pa and 1300 Pa (around 13 Pa/m). The pressure will then typically return to the original pressure (i.e. the pressure at that particular ground level of the aircraft) with this pressure spike lasting for less than 1 second and usually around 0.3 seconds in total. Therefore, such an example pressure change event or signal can be detected by pressure sensors and timers also indicating that the aircraft has changed from a non-operational to an operational state indicating that the aircraft will shortly take off. This can correspond with the time that passengers are instructed to manually place their mobile devices in flight safe mode.

An additional or optional check (i.e. representing another example pressure change event) is to determine that the aircraft has actually taken off and this also may be indicated by pressure changes. However, in this case the pressure changes may be more gradual and represent a reduction in pressure equivalent to an altitude change of greater than around 700 to 1000 metres. This may occur over a period typically greater than 30 seconds. Any or all of these criteria may be used in combination in order to definitively determine the operational state of the aircraft.

A particular benefit of the combination of sensing electromagnetic frequency, magnetic flux density and pressure changes (as well as optional movement sensors) is that each of these physical detected phenomena originates from a very different source type. Therefore, this provides a very high confirmation level specific to the operational state of an aircraft and reduces the occurrence of a false-positive result.

Whilst the indication of a change of operational state of an aircraft is important in itself, this information may be used to take other actions. These actions may be varied, for example when an aircraft is determined to be in an operational state or change from a non-operational state to an operational state then one or more actions may include changing a powered state of a device, disabling a transmitter, a receiver, a sensor, an oscillator and/or other functionality of a device that may be external, linked to or part of the same device that is carrying out the measurements and processing of those measurements. This detection may also be used to automatically place a device in flight-safe mode without requiring user intervention.

Preferably, the measurement system (including sensors and one or more processors) may be powered from a source external to the aircraft. This power source may include a battery or an energy harvesting device that may be powered from vibrations, heat, and/or solar. The energy harvesting device may the similar to that described in WO2017/187208, for example.

In order to reduce the power necessary to carry out the measurements and measurement processing, various techniques can be used. For example, the sensors and/or processor may be operated at intervals or other external sensors may be used to initiate a sensing event. For example, accelerometers may be used to detect movement and only when movement is detected then the measurement device wakes up to carry out the measurements. This can be useful for cargo which is being loaded onto an aircraft as the loading function provides sufficient movement to be detected by one or more accelerometers within the measurement device. The accelerometer data itself may be validated to determine that it relates to a loading event. For example, the movement may be compared with pressure changes indicating that baggage or cargo is being loaded form a ground height to a height of a cargo bay of an aircraft, which itself may have a particular movement and pressure signature or be detecting using the accelerometer.

Therefore, a more accurate and effective way of determining an operational state of an aircraft is provided and this can be external to the aircraft itself. This is advantageous as each aircraft does not need to be modified to provide a signal indicating their change of state. Furthermore, equipment that would otherwise be banned or not usable within an aircraft can be safely used, as detection of the operational state of the aircraft can have the effect of disabling those functions that would otherwise not be allowed within an operational aircraft.

In accordance with a first aspect there is provided a method of detecting an operational state of an aircraft, the method comprising the steps of:
conducting passive measurements including:
   measuring an electromagnetic frequency at a location;
   measuring a magnetic flux density at the location; and
   determining that the aircraft is in a powered state when criteria are met,
wherein the criteria include:
   the measured electromagnetic frequency is between 370 Hz and 1 kHz; and
   the measured magnetic flux density is between 9 nT and 9200 nT. This method improves the accuracy in which the aircraft operational state can be detected without requiring a direct or indirect interface with the aircraft. Therefore, particular actions, timings or measurements may be taken regarding the aircraft state independently of the aircraft systems. The aircraft may be a commercial, freight, passenger, private, fixed wing or rotary wing aircraft, for example. Such aircraft typically, include an electrical system that operates with particular characteristics, when the aircraft is in particular operational states, such as when the aircraft engines are running.

Preferably, the method may further comprise the step of changing state of a device when the aircraft is determined to be in the powered state or determined to change to a powered state. Other actions may take place.

Optionally, the change of state may a change from a higher power mode to a lower power mode. Other changes may be configured in response to the criteria being met.

Optionally, the change of state may be to the lower power mode turns off or disables any one or more of: a transmitter, a receiver, a sensor, an oscillator, and/or a processor. The entire device may also be turned off, for example.

Optionally, the device may be an external device or a device integrated with one or more sensors arranged to measure the electromagnetic frequency and/or the magnetic flux density. In other words, the method may use one apparatus or system to control one or more devices. For example, the apparatus or system may connect to the one or more devices by a wired (or perhaps wireless) connection. The apparatus or system may then control the one or more devices over such an interface. Alternatively, the apparatus may be incorporated within the one or more devices so the apparatus may control the overall system depending on the determined operational state of the aircraft.

Optionally, the passive measurements may further include:

measuring air pressure at the location and wherein the criteria further include the measured air pressure is below 90 kPa. Any such air pressure measurements may be acquired by a pressure sensor (preferably solid state), such as a barometer, for example. This particular value can indicate that the interior of the aircraft has a reduced pressure consistent with a commercial aircraft in the air. This is because commercial aircraft are usually pressurised to a pressure slightly above sea level pressure (e.g. corresponding to 1000 m). Whilst such a measurement indicates that the aircraft has been in an operational state for some time (e.g. take-off has already occurred), this provides a backup or failsafe for determining the operational state of the aircraft should other sensors fail, for example.

Optionally, the passive measurements may further include:

measuring air pressure at the location and wherein the criteria further include the measured air pressure increasing by equal to or greater than 780 Pa and then decreasing by equal to or greater than 780 Pa over a period of less than one second. This provides a further and independent determination that the aircraft state has become operational. This particular pressure signature or change (again may be measured by a barometer or other suitable pressure sensor) indicates that that the doors and/or cargo bay of the aircraft have closed, the interior of the aircraft (where the measurements take place) has become a closed pressure vessel and any pressurisation valves have closed or at least partially closed. The aircraft's pressurisation system will then typically increase the cabin pressure by an amount equivalent to a descent of around 60-100 m. At sea level this represents an increase in pressure of around 780 Pa. This pressure increase occurs rapidly over a period of less than one second and typically 0.3 s during which time the pressure returns to the original value similar to that of the ground level at the airport. It is this momentary spike in pressure that is detected and provides an additional confirmation that the aircraft operational status has changed. This is because pressurisation relies on power supplied by the aircraft's engines. In some example implementations, it is only this pressure change signature that needs to detected (e.g. using a system or apparatus) to determine the change in aircraft operation status (i.e. the electromagnetic frequency and magnetic flux measurements are not required). However, this example implementation may be used with any of the other described features.

Preferably, the passive measurements may be conducted at intervals. This conserves battery power prolonging the life of the apparatus or system before battery changes or charging is required.

Optionally, the passive measurements may be conducted when or after movement is detected. This can provide another prompt to conduct measurements (i.e. in addition to or instead of the interval detection process).

Preferably, movement may be detected by an accelerometer. This can be a solid state accelerometer, for example.

Optionally, the method may further comprise the step of:

determining that the aircraft is in a non-powered stated if the criteria are not met. Such a step may take place after it has been determined that the aircraft is in a powered state and so may occur after a flight and/or shut-down of aircraft engines.

Preferably, the method may further comprise the step of changing state of a device when the aircraft is determined to be in the non-powered state or to change to the non-powered state.

Advantageously, the change of state may be a change from a lower power mode to a higher power mode.

Optionally, the change of state to the higher power mode turns on any one or more of: a transmitter, a receiver, a sensor, an oscillator, and/or a processor. In some example implementations, a device (either integral or external to apparatus making the measurements) is powered back on or has certain functionality restored following this determination. In other words, the method and system can go through one or more cycles of changing state when it is determined that an operational state of the aircraft has occurred. This may be constantly monitored (e.g. at intervals or following particular events such as movement detection).

According to a second aspect, there is provided an apparatus for detecting an operational state of an aircraft, the apparatus comprising:

one or more sensors configured to:
measure an electromagnetic frequency at a location, and
measure a magnetic flux density at the location, and

one or more processors configured to:
receive data from the one or more sensors, and
determine that an aircraft is in a powered state when criteria are met,
wherein the criteria include:
   the measured electromagnetic frequency is between 370 Hz and 1kHz, and
   the measured magnetic flux density is between 9 nT and 9200 nT.

Optionally, the one or more processors may be further configured to change a state of a device when the aircraft is determined to be in a powered state or determined to change to a powered state.

Preferably, the change of state may be a change from a higher power mode to a lower power mode.

Optionally, the change of state to the lower power mode may turn off any one or more of: a transmitter, a receiver, a sensor, an oscillator, and/or a processor.

Optionally, the device is an external device to the apparatus, the apparatus further comprising an interface to the device.

Optionally, the interface is a wired or wireless interface.

Optionally, the one or more sensors may be further configured to measure air pressure at the location and the criteria further include:

the measured air pressure is below 90 kPa;

the measured air pressure increasing by equal to or greater than 780 Pa and then decreasing by equal to or greater than 780 Pa over a period of less than one second; and/or the measured air pressure indicating a rise in altitude of above 3 m in less than 60 s.

Advantageously, the apparatus may further comprise at least one centred moving average filter configured to filter a signal received from the air pressure sensor. This may be used to reduce noise in the signal and so act as a low pass filter, for example.

Optionally, the apparatus may further comprise one or more accelerometers, wherein the one or more processors is further configured to:

determine an orientation of the apparatus based on signals received from the accelerometer. The accelerometer may also be used to detect changes in height, for example. Particular changes in height (as indicated by the accelerometer and/or pressure signals) may be used as verification that the aircraft is in an operational state. This may provide further verification or validation (as primarily indicated by the electrical and magnetic signals) or used independently.

Optionally, the apparatus may further comprise a centred moving average filter configured to filter a signal received from the accelerometer. Again, such a filter may be used to reduce noise in the signal and provide low pass filtering.

Preferably, the moving average filter(s) is/are further configured to perform a calibration over a time period. For example, this time period may be five to 10 seconds. The calibration may be an adaptive calibration obtained by sampling based on an average signal from the accelerometer and/or the pressure sensor.

Optionally, the centred moving average filter or filters may be provided by instructions executed by the one or more processors. Alternative, such functionality may be provided by hardware such as dedicated circuitry, for example.

Optionally, the one or more sensors may include any one or more of:

a coil;

an accelerometer;

and a pressure sensor. Other sensors may be included and there may be one, two, three or more of the same sensor type within the apparatus.

Preferably, the one or more processors may be further configured to power the remaining sensor or sensors when the accelerometer detects movement. Between movement events, the processor may be configured to not power the other sensors and/or enter a low power or sleep state.

Preferably, the apparatus may further comprise a band pass filter configured to pass 370 Hz to 1 kHz. This feature provides discrimination or determination of the particular frequency or frequency range of the criteria as other frequencies are filtered out.

Optionally, the apparatus may further comprise a programmable gain amplifier, PGA, in series with the band pass filter. The PGA may be used to determine the magnitude of the magnetic flux density.

Preferably, the PGA may be configured to increase gain when an electromagnetic frequency of between 370 Hz and 1 kHz is detected.

Preferably, the PGA may be configured to increase gain at intervals. This may also reduce overall power consumption of the apparatus.

Optionally, the apparatus may further comprise an analogue to digital converter, ADC, configured to receive an input from the PGA and to provide a digital output signal corresponding to the received input.

Advantageously, the one or more sensors may be further configured to measure the electromagnetic frequency and magnetic flux density at the location in one, two or three orthogonal dimensions. This may require one, two or three separate sensors and/or receiving/detection components such as coils, for example. Each of these sensors may be a tuned circuit, e.g. also comprising a capacitor.

The methods described above may be implemented as a computer program comprising program instructions to operate a computer. The computer program may be stored on a computer-readable medium.

The computer system may include a processor or processors (e.g. local, virtual or cloud-based) such as a Central Processing unit (CPU), and/or a single or a collection of Graphics Processing Units (GPUs). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operating system such as UNIX, Windows (RTM) or Linux, for example.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of a system, including one or more sensing modules, for detecting an operational state of an aircraft;

FIG. 2 shows a schematic diagram of the sensing module of FIG. 1 including a resonant circuit, a programmable gain amplifier and a bandpass filter;

FIG. 3 shows a schematic diagram of a printed circuit board of the sensing module of FIG. 1;

FIG. 4 shows a schematic diagram of a coil used within the sensing module of FIG. 1;

FIG. 5 shows a schematic diagram of a method for detecting an operational state of an aircraft;

FIG. 6 shows a schematic diagram of components used to form an apparatus for detecting the operational state of an aircraft;

FIG. 7 shows graphical results of data generated from the system of FIG. 1;

FIG. 8 shows a flowchart of a method for detecting the operational state of an aircraft;

FIG. 9 shows a flowchart of further steps of the method of FIG. 8;

FIG. 10 shows a flowchart of further steps of the method of FIG. 8;

FIG. 11 shows a schematic diagram of a portion of the system of FIG. 1;

FIG. 12 shows a flowchart of a method for operating the programmable gain amplifier of FIG. 2;

FIG. 13 shows a schematic diagram of a test environment used to test the system of FIG. 1;

FIG. 14 shows a timing diagram of the operation of the system of FIG. 1;

FIG. 15 shows a schematic diagram of the sensing module of FIG. 2;

FIG. 16 shows a schematic diagram of a further sensing module of FIG. 2;

FIG. 17 shows a schematic diagram of a further example system for detecting the operational state of an aircraft;

FIG. 18 shows a high-level schematic diagram of an alternative system for detecting the operational state of an aircraft, the system including a power management system;

FIG. 19 shows the power management system of FIG. 18;

FIG. 20 shows a flowchart of an alternative method for operating the system of FIG. 17; and

FIG. 21 shows a schematic diagram of firmware used within the system of FIG. 17.

It should be noted that the figures are illustrated for simplicity and are not necessarily drawn to scale. Like features are provided with the same reference numerals.

### DETAILED DESCRIPTION OF THE PREFERRED EMBODIMENTS

In a particular example embodiment a system or apparatus 10 causes a device to enter a flight-safe mode, e.g. turning off, disabling and/or preventing from transmitting one or more transmitters, transceivers or any other type of electrical interference-generating feature, within the device. This may be a GSM or any other type of cell phone radio, GPS chip, WiFi, Bluetooth or any other long or short range transmitter used for SMS, voice call or other communication purpose. The device will typically communicate with a mobile operator using its SIM. In this flight-safe mode or state the device may otherwise be powered and function but in accordance with aircraft restrictions. The apparatus 10 (that may be self-contained, battery operated, and/or otherwise independent or unconnected with the aircraft) has one or more sensors to detect that the aircraft is or is about to start its journey (i.e. take-off). Alternatively, the apparatus 10 may be separate from the device but changes the device's mode when within an aircraft interior that is or becomes operational.

The apparatus 10 operates according to a method of operation, which uses the sensor(s) to detect one or more physical or environmental changes, criteria and/or measurements. These sensors may measure movement, configuration, electrical disturbances or electromagnetic fields or magnetic variances that may indicate or have a particular pattern or signature that provides an indication or confidence level that the aircraft is about to or has taken off or is airborne. Multiple sensors and/or signatures may be used to confirm or increase this confidence level (that may be compared against one or more thresholds, for example).

Accelerometers or other movement detectors (e.g. a gyroscope) may indicate that a particular combination of movements has or have taken place (or movements of an item attached to or enclosing the apparatus 10). The signature or movement characteristics may include being or raising the apparatus 10 to a specific height above the ground that may be associated with a particular type of aircraft. For example, this movement may be at or within a particular threshold of an acceleration in a specific course of movement (e.g. from a ground level to a cargo bay or passage cabin).

The sensor(s) may include one or more pressure sensor(s) that may also detect a particular change in pressure associated with cabin pressure changes experienced when one or more engines start. This may be due to valves opening and closing either automatically or manually to pressurize the cabin (including any cargo bay or hold). Again, particular data signatures and/or changes over time may indicate that this is happening and a matching process or algorithm may provide an output (either binary or with a confidence level compared to a threshold) indicating that this event or events have occurred. This signature may be generally applied to all aircraft types or may be specific to one or more aircraft and such thresholds or signatures may be stored within the device for comparison, for example.

Similarly, the aircraft electrical power system may provide a particular and detectable electrical, magnetic and/or electromagnetic signature that can be detected (e.g. by a passive receiver/antenna on the apparatus 10), indicating that either the engine(s) has started or that the aircraft is about to take off or is already airborne. This electromagnetic frequency may be at a particular frequency and/or amplitude signature (e.g. detected using low/high/bandpass filtering). The detection of the electromagnetic signature may include the use of computing resources but can also be implemented in a fully analogue way, for example.

Any combination of these sensors and/or matching or signalling algorithms may be used to improve the accuracy of the decision making process so that airplane mode or other reductions in unwanted HF, UHF, VHF and/or GHz transmissions (including both long and short range interference) can be achieved automatically.

Similarly, the aircraft or flight-safe mode may be disabled when it is determined that the aircraft is no longer in an operational state. Under these circumstances, the various functions that were prevented or disabled (e.g. transmissions) may be restarted. This may depend on the sensor(s) providing signals or data indicating that the aircraft has landed and that it is safe to do so. For example, the sensor(s) may no longer detect the particular electromagnetic frequency at a particular amplitude and/or in combination with receiving pressure data indicated that the system 10 is no longer within a pressurised interior of an aircraft. A redundancy strategy may be used to ensure system robustness. For example, the pressure changes detected may indicate that the cargo or other doors have or are now open (or simply that one or more valves have operated to bring the cabin pressure in line with ambient or ground atmospheric pressure) or that the engines have stopped or significantly reduced power output. Similar orientation detections (e.g. using one or more accelerometers and/or gyroscopes) may also be detected and interpreted as the device is moved (e.g. brought out from the cargo bay).

In this way, devices may be safely transported in environments, such as aircraft, that restrict electrical and radio frequency interference, whilst allowing the devices or items associated with those items, to be tracked or at least in communication with other systems, when it is safe to do so (i.e. on the ground or during ground transportation). This may also be used when such transmissions are not allowed due to other (e.g. security) reasons or to ensure that certain devices or systems are active when required within the presence of the aircraft interior.

Any of these detectors and sensors (with corresponding signatures) may be used in isolation or in combination with any other detectors.

The system, method and apparatus are not limited to tracking goods or packages, but may be added to items that may be present on aircraft, e.g. at or around airports. This may include maintenance equipment, aircraft parts (e.g. engines), communication equipment or other items deliberately or accidently (e.g. left unexpectedly by personnel) transported on to aircraft. The system, method and apparatus may also be used to save battery, power, bandwidth and/or computing resources by restricting modes of operation (beyond flight safe mode) when the device detects a particular environment, location, pressure or orientation, for example. This may involve the detection of other criteria or environmental signatures, for example. The apparatus may also be used to provide a warning or recording (e.g. timestamped) of aircraft operational states.

The description below provides an example implementation, but alternative components and functions may be used.

The method may be part or wholly operated as computer code stored within memory and operating on one or more processors within the device. The methods described above may be implemented as a computer program comprising program instructions to operate a computer. The computer program may be stored on a computer-readable medium.

The computer system may include a processor or processors (e.g. local, virtual or cloud-based) such as a Central Processing unit (CPU), and/or a single or a collection of Graphics Processing Units (GPUs). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operating system such as UNIX, Windows (RTM) or Linux, for example.

It should be noted that any feature described above may be used with any particular aspect or embodiment of the invention.

The system or apparatus detects if a device (e.g., a tracker or a cell phone) is located within or close to an aircraft. In a particular embodiment, the system enables confirmation that a device is within the interior of an operational commercial aircraft or other vehicle or object.

The apparatus uses an embedded algorithm that uses a sensor tile hardware containing sensors that may include any combination of: a 3D accelerometer, a pressure sensor; and/or one or more magnetic field pick up coils.

Electrical and magnetic field sensor detection can be used to detect aspects of an aircraft electrical system. Most commercial aircraft have a 115 v/400 Hz power supply used to power alternating current (AC) electrical equipment on the aircraft. However, some aircraft may have different frequencies and the system may use these alternative frequencies but these are typically between 370 Hz and 1 kHZ. AC is used to minimize weight and required power levels. As 400 Hz is common between many aircraft manufacturers and aircraft types at present, it is unlikely to change in the near future. This frequency current is not used in any other commercial/domestic applications outside of aviation at this time.

A signature indicated by sensing a magnetic and/or electromagnetic field as generated by the power supply (e.g. but not limited to 400 Hz AC) current is a reliable indicator of proximity to an operational aircraft. When aircraft electrical systems are operating, the current in individual and collective conductor wires generate a magnetic flux that also alternates at e.g. usually but not limited to 400 Hz frequency. The detection method is sensitive enough to work when installed even inside a container, which may house the apparatus or cargo, for example. In an example embodiment, one or more sensitive electromagnetic pickup coils together combined with concentrator material enhances sensitivity.

Preferably, the system can detect multiple frequencies ranges. Aircraft usually have a highly controlled power system but not all commercial aircraft operate on the same frequency. Therefore, the system can adapt automatically to any required electromagnetic or magnetic frequency or pattern. The apparatus 10 remains a passive system.

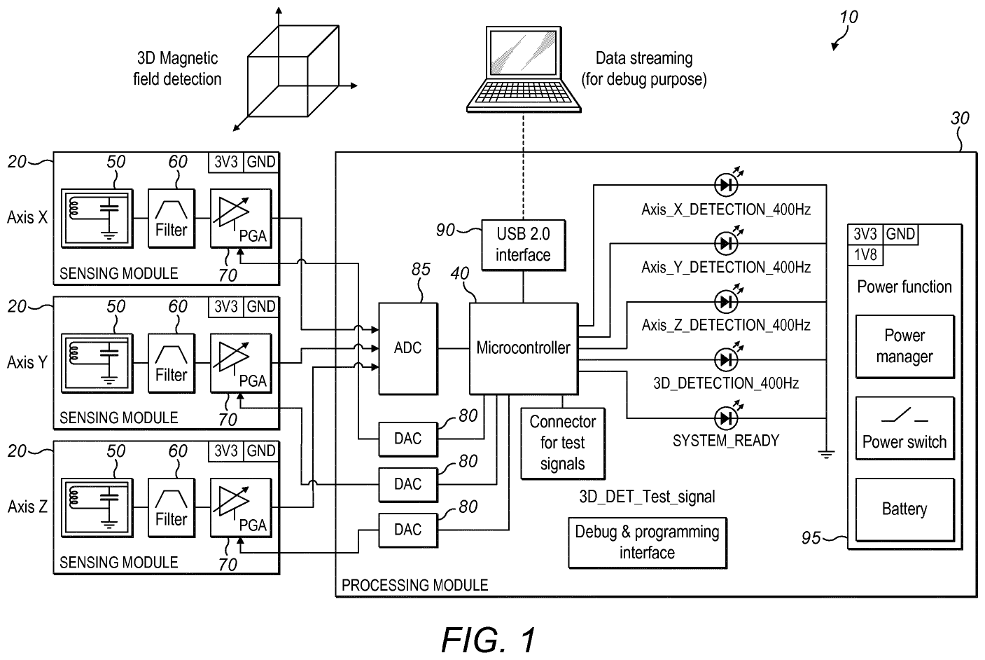

FIG. 1 shows a schematic diagram of the apparatus 10 for determining an operational state of an aircraft. This example apparatus 10 includes three sensing modules 20, which detect an electromagnetic field in three separate dimensions (x, y and z). However, it is sufficient to include only one or two sensing modules 20. Preferably, the coils are orthogonal. Processing module 30 uses data generated from each of the three sensing modules 20 to make the determination as to the operational state of the aircraft (not shown). Such analysis is carried out by the controller 40. Each sensing module 20 includes a tuned circuit 50 comprising at least a coil and a capacitor. The signals received by the tuned circuit 50 are filtered using a bandpass filter 60 and the resultant signal is amplified by a programmable gain amplifier (PGA) 70 for each sensing module 20. The microcontroller 40 controls each PGA 70 using three separate digital to analogue converters (DAC) 80. The output from each PGA 70 is received by an analogue to digital converter (ADC) 85, which is in communication with the microcontroller 40. The microcontroller 40 provides a set of outputs indicating detection at the frequency or frequency range that passes through each bandpass filter 60. A functional power supply unit 95 includes a battery, power switch and power manager for powering the processing module 30 and sensing modules 20. A USB interface 90 (e.g. FTDI) enables additional data output and data input to be used for connecting to an external computer for debugging purposes, for example. Furthermore, the USB interface 90 may be used as a power source to charge the battery within the power function 95. An example microcontroller 40 may be STM32L4 provided by ST Microelectronics (RTM) having UART interfaces.

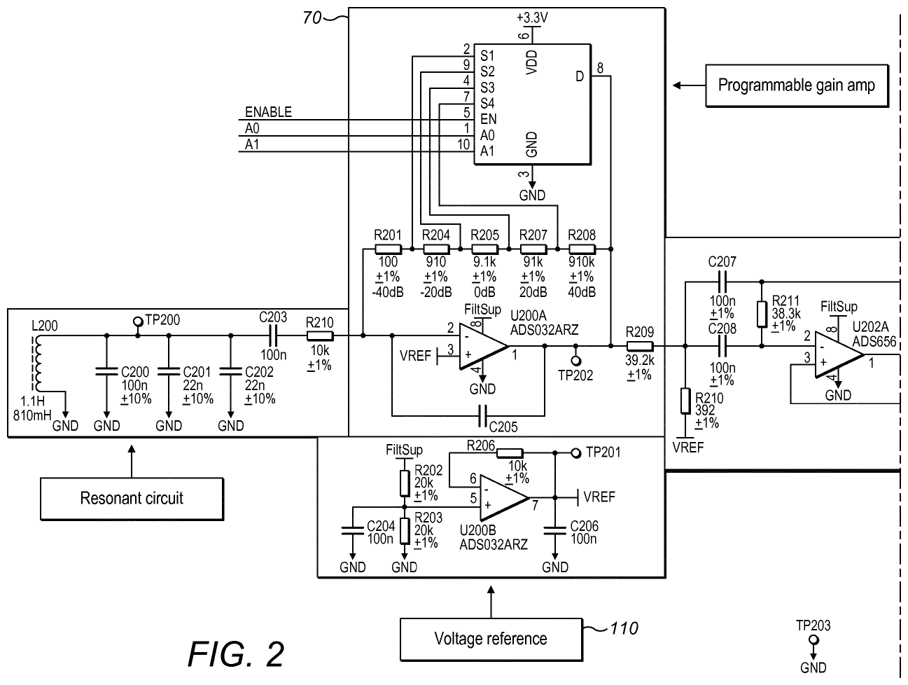

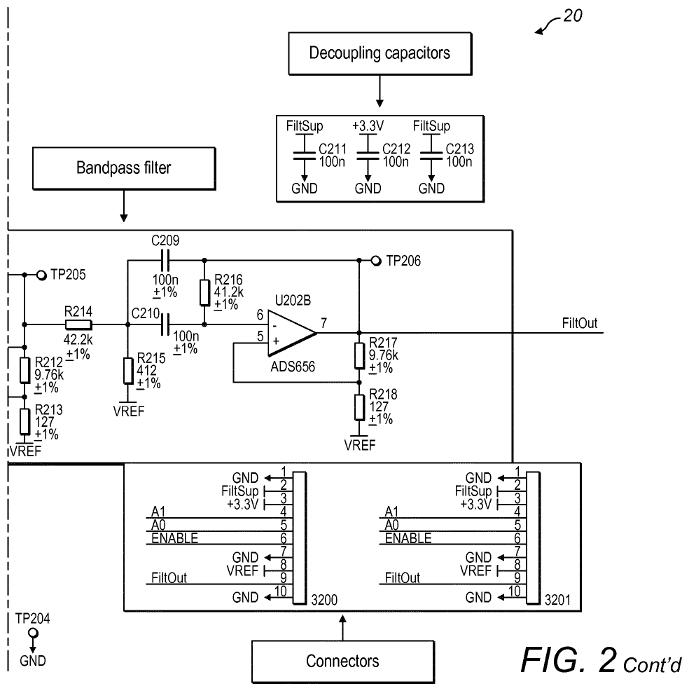

FIG. 2 shows a schematic diagram of a single sensing module 20 (i.e. any one of the three similar sensing modules shown in FIG. 1). This figure shows in more detail a tuned or resonant circuit 100, a voltage reference circuit 110, the bandpass filter 60, the PGA 70. Coupling capacitors 140 are shown, which smooth various voltages within the apparatus 10. Connectors 150 provide a wired interface for the apparatus 20.

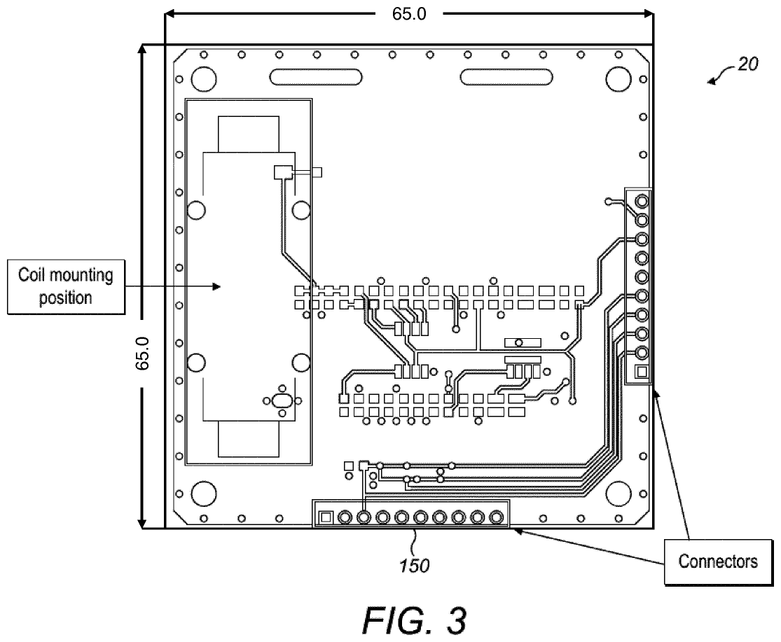

FIG. 3 shows a schematic diagram of a printed circuit board (PCB) 200 used to mount the components of the sensing module 20. This PCB holds a coil of the tuned circuit and this figure illustrates the connectors 150 along two of the edges of the PCB 200. A single coil mounting position is shown and so two or three similar boards may be used to provide orthogonal (X, Y, Z) sensing modules 20.

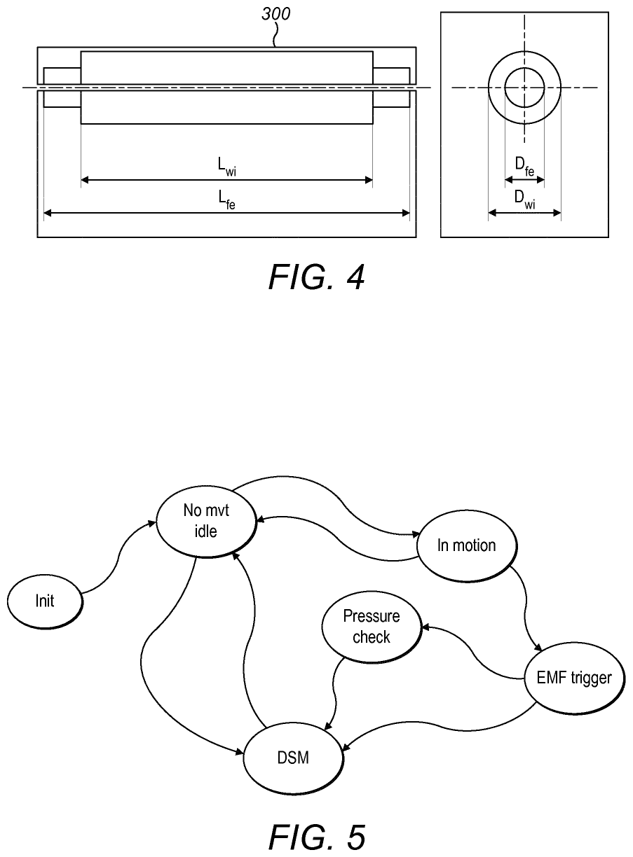

FIG. 4 shows a schematic diagram of an example coil 300 used within the sensing module 20. Different coils may be used depending on the sensitivity and space requirements for the apparatus 10. Table 1 below shows example properties of two different coils 300. Other different coils and dimensions may be used.

TABLE 1

| | No. of | L_{fe} | D_{fe} | L_{wi} | D_{wi} | | | Number of |
|---|---|---|---|---|---|---|---|---|
| Variant # | coils | [mm] | [mm] | [mm] | [mm] | Wire Φ [mm] | Number of layers | Windings C |
| 1 | 5 | 35 | 5.0 | ≈30 | ≤8.0 | Back Paint wire | 16 layers and 375 | ≈6000 |
| | | | | | | CuL 0.08 | convolutions | |
| 2 | 5 | 45 | 8.0 | ≈35 | ≤12 | Back Paint wire | 16 layers and 350 | ≈5600 |
| | | | | | | CuL 0.1 | convolutions | |

In order to ensure that the tuned circuit 100 has the correct resonant frequency (at or around 400 Hz), particular parallel capacitors may be added to the sensing module 20. The following formula indicates an example calculation for determining a particular parallel capacitor value.

$${f}_{0} := 400 Hz = > {ω}_{0} := 2 \cdot \prod \cdot {f}_{0} = 2.513 \frac{krad}{s}$$

$${L}_{s} := 850 mH$$

$${R}_{s} := 460 Ω$$

$${X}_{L} := {ω}_{0} \cdot {L}_{s} = 2136.283 Ω \\ {Q}_{L} := \frac{{X}_{L}}{{R}_{s}} = 4.644 \\ {C}_{par} := \frac{1}{{ω}_{0}^{2} \cdot LS} = 0.186 μ F$$

Different coils may have different gain values but larger coils (having higher gain and sensitivity) require more space.

Table 2 shows values of these different gains for two separate sized coils when exposed to particular magnetic flux (generated by a Helmholtz coil).

TABLE 2

| | | | Ferrite Coil | Preamplifier | Filter |
|---|---|---|---|---|---|
| | | Helmholtz | Output | Output | Output |
| | Gain | Coil | Voltage | Voltage | Voltage |
| | Setting | Current | [mV] | [mV] | [mV] |
| Board # | [dB] | [mA] | TP200 | TP202 | TP206 |
| Medium Coil | 80 | 0.01 | 4.46 | 8.42 | 444 |
| | 60 | 0.1 | 4.53 | 6.29 | 470 |
| | 40 | 1 | 7.06 | 6.27 | 467 |
| | 20 | 10 | 54.20 | 6.56 | 465 |
| | 0 | 100 | 536.00 | 6.34 | 467 |
| Large Coil | 80 | 0.01 | 3.88 | 23.20 | 688 |
| | 60 | 0.1 | 4.39 | 10.40 | 803 |
| | 40 | 1 | 10.50 | 9.93 | 800 |
| | 20 | 10 | 97.50 | 9.81 | 801 |
| | 0 | 100 | 930.00 | 10.90 | 778 |

FIG. 5 shows an example use case for the system 20. In this example use case, the system includes a pressure sensor to detect a particular pressure signature or set of changes. Such a pressure sensor will be described in the following sections.

The use case of FIG. 5 starts with initiation of the apparatus 10. When no movement is detected then the apparatus 10 remains in an idle state. When motion is detected (e.g. by an accelerometer) then the sensing module 20 detector is activated. When an electromagnetic signal of particular range or value (e.g. 400 Hz at a particular amplitude, as detected by the PGA 70), then the pressure checks are made by the pressure sensor to determine that the ambient pressure or a pressure change matches a particular criteria. When these checks both meet the particular criteria then a device (e.g. an external device) is set into a deep-sleep mode (DSM). The apparatus 10 itself may also go into a sleep mode and be reactivated at intervals to check the environment and the operational state of the aircraft.

The apparatus 10 may start the detection process once an arbitrary acceleration or movement has been detected. This may be caused by cargo bay loading detection, which initiates the detection of the specific range of magnetic flux density at the specific range of frequencies. The pressure signature may also be detected, if required or necessary. The embedded design supports multiple sequential scenarios powered by redundant hardware components to deliver a reliable and robust performance.

The apparatus 10 may operate an initial calibration and warm up. This may be followed by detection of movement, which can cause the processor to check if the EMF status trigger has met a particular predetermined threshold or criteria, i.e. a function of frequency and magnetic flux density.

If the EMF threshold or criteria are met the apparatus 10 (and/or connected device) goes to a Deep sleep mode (DSM). Otherwise, the apparatus 10 may go on to check the pressure threshold or criterial which may be designated by a specific triaxle signature.

When in DSM the wake-up process may be triggered by a digital timer which may be configurable, for example.

In an example implementation, one or more sensor measures are acquired or polled within an interrupt driven by one or multiple timers configured at a 500 Hz and/or 2300 Hz sampling rate. The raw data is buffered and written to a data storage unit “S”. The raw data is then filtered and processed. The according state changes, these measurements may be be sent to a terminal and are stored on a log file on S, for example. S may be flash memory, for example.

Each sensor is polled by a timer driven interrupt service routine with a frequency of 500 Hz, which is a convenient frequency for different clock sources operating at different sample rates. The data is sent to the data ring buffer with a size of 1024 datasets. The buffer is subdivided into multiple sections and as soon as at least one section is full, the data is written and processed.

The data storage unit may have an extended data pool, where each data sample may be polled a further timer driven interrupt service routine with a frequency of 2300 Hz. This data pool consists of a two block ping pong buffers that are each composed of 3000 samples.

The ADC will sample on three channels (corresponding to the three sensor modules 20) that will be filled by the magnitude vector data for further processing and filtering. For the pressure filtering and processing, before the data can be processed, the acceleration values of the accelerometer sensor (ACC) and the values of the pressure sensor are filtered by a moving average filter and buffered in a second ring buffer. The filtered data will then be processed and when an event has been detected, it will be passed to the general state machine.

For magnitude processing, an RMS computation is performed at specific timeslots and frequency. Therefore, the processed samples that are polled by the ADC over the three channels become a magnitude vector resultant and may be used to determine the specific magnetic threshold detection (i.e. the magnetic flux density).

The microcontroller 40 includes a real-time clock. The timestamps from this clock are recorded and stored together with the sensor values. Therefore, the state changes can be determined relative timestamps starting at the point where the microcontroller is switched on. The resolution in this example is two milliseconds.

In summary, the apparatus 10 preferably includes: and ultra-low-power control unit having an ARM core; an accelerometer; a barometer (optional); controlled magnetic field pickup coil(s); and a low power management unit.

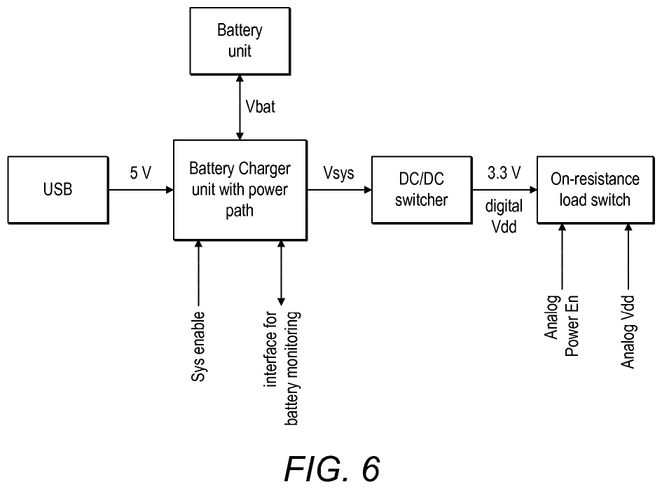

FIG. 6 shows a further schematic diagram of the apparatus 10 indicating how the power function 95 operates together with the USB interface 90. FIG. 6 shows a battery charger used to charge the battery unit and a DC/DC voltage regulator used to provide the different voltages necessary for each of the separate components. The battery charger includes battery monitoring and functionality to power the apparatus 10. These components enable the DSM to be activated or deactivated when appropriate.

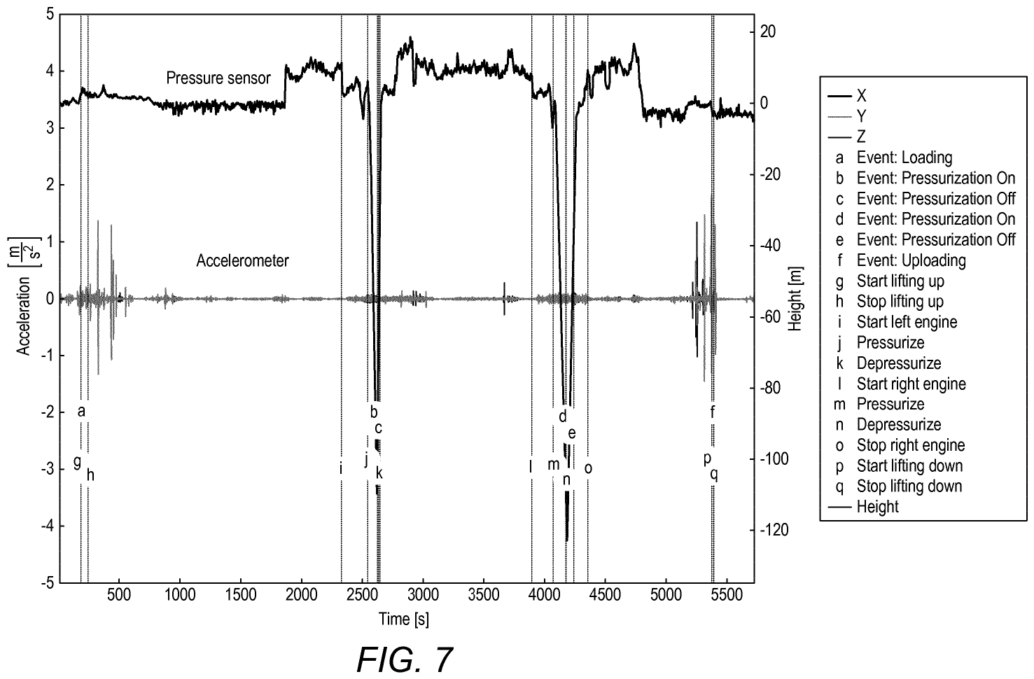

FIG. 7 shows a graph (plotted using Matlab) of pressure and accelerometer measurements taken from a double aisle aircraft during a particular test. The unit of pressure is equivalent height in meters relative to sea level. This graph shows particular pressure signatures that correspond to particular flight events. In particular, cargo loading mode is detected based on transitions (a, g, h) and unloading (f). The pressurization of the aircraft is indicated by particular events (b, c, d, and e). Other events and pressure signatures are indicated in the graph. In particular, the momentary pressurisation events are shown (b-c and d-e), where the pressure changes are equivalent to a reduction in altitude of around 120 m over less than a few seconds. The engines are started at events i and I and stopped at events h and o. These results are taken from a test and do not necessarily show the same order of events from a scheduled flight.

Filtering of the pressurization and accelerometer (ACC) signal are achieved using centred moving average filters providing a low pass filter. In order to avoid accelerometer noise, two digital filters are used for the ACC and pressure sampling data. As the apparatus will not have always a defined starting data point for positioning, a method has been developed to obtain a self-adaptive acceleration calibration for any starting position or device orientation. This is based on knowledge that the vertical axis will be perpendicular to the ground. Moreover, this adaptive calibration is obtained by subcontracting a precise number of samples based on the average signal that is referenced at an initial location during a processing block. In this example, a five seconds time slot is used to self-calibrate during initialization of the apparatus 10. This improves the reliability of the data should horizontal alignment be insufficient.

This self-adaptation processing may always take place during acceleration measurements. This filtering method isolates vertical-accelerations and may be used to define a stored threshold, which can be used with a corresponding pressure value. If the measured delta pressure/height is higher than a certain value or threshold then it may be determined that the signals indicate that the operational state of the aircraft is now in a powered mode (e.g. the apparatus is now cargo within an operational aircraft. Particular functions may be enabled (e.g. disabling transmitters or entering flight-safe mode). Otherwise, it may be determined that the apparatus 10 is not within an operation aircraft and flight-safe mode can be disabled.

This data signatures illustrated in FIG. 7 can be used as a further confirmation regarding aircraft operational state. These signal signatures may also be used on their own to determine such as state with another example apparatus containing only a pressure sensor and optional accelerometer.

The electromagnetic magnitude and frequency detection sensor operates preferably within the range of 370 Hz to 1 kHz and preferably 370 Hz to 800 Hz. Such frequencies are generated by EMF resulting from the power cables inside commercial aircraft. A specific and magnetic pickup coil is used. Such frequency detection is therefore passive and the coil has a specific number of windings C.

The aircraft electromagnetic radiation is detected at this specific range of frequencies and at a specific magnetic flux density (e.g. amplitude). The aircraft operational state can be determined based on this sensor information and after algorithm-based data processing.

In an example apparatus 10, a magnetic or electromagnetic sensor detects the presence within or the proximity to a cargo bay or passenger cabin of an operational aircraft. The apparatus 10 of this example comprises:
1. A one-way passive receiver pick up magnetic coil controlled by an automatic gain controller with the ability to sense nT signals resulting from magnetic flux density variations within the aircraft.
2. A three-dimensional movement sensor (e.g. accelerometer and/or mPa pressure sensor) to detect movement or pressure changes that may be compared against specific thresholds or signature changes.
3. Low power design provided by specific logic and timing parameters using optimized data filtering, which provides results quickly and efficiently.
4. Moving average filtering to further improve power reduction and enhance reliability.
5. One or more pickup coils with specific ferrite core material, specifically designed for low power operation.
6. Direction independent field detection with redundant operational design to ensure reliability.
7. A control unit to process sampled data directly through the memory for fast response times and providing redundancy.

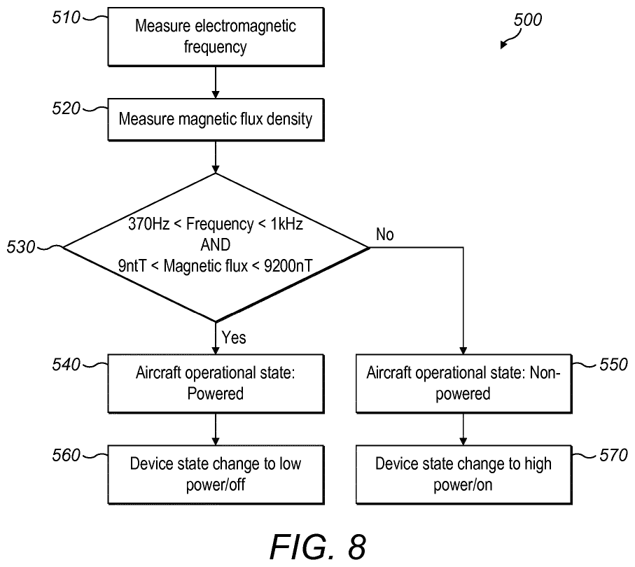

FIG. 8 shows a flowchart of a method 500 for operating the system 10. This method does not utilise the optional pressure sensing functionality. When the apparatus 10 determines that an electromagnetic measurement needs to take place (e.g. triggered by a timer or upon detecting movement), this measurement occurs at step 510. This measurement utilises the sensing module 20 that detects a particular range or value of electromagnetic frequency (e.g. 400 Hz). The amplitude of this signal is measured in terms of a magnetic flux density at step 520. This amplitude or flux density is measured using the PGA 70. Step 530 determines whether a frequency in the correct range has been detected and whether the amplitude of the magnetic flux is between 9 nT and 9200 nT. If it is and both criteria met then the aircraft is determined to be in an operational state (i.e. powered) with the engines running (step 540). An attached or integrated device may be altered to change its power mode to low or off at step 560. If either or both the frequency and magnetic flux density are outside of the particular ranges then the aircraft is determined to be in a non-powered operational state at step 550 (or no aircraft is present). If the aircraft was previously determined to be in an operational or powered state then the device attached to or integrated with the apparatus 10 is changed from low to high power or powered on at step 570.

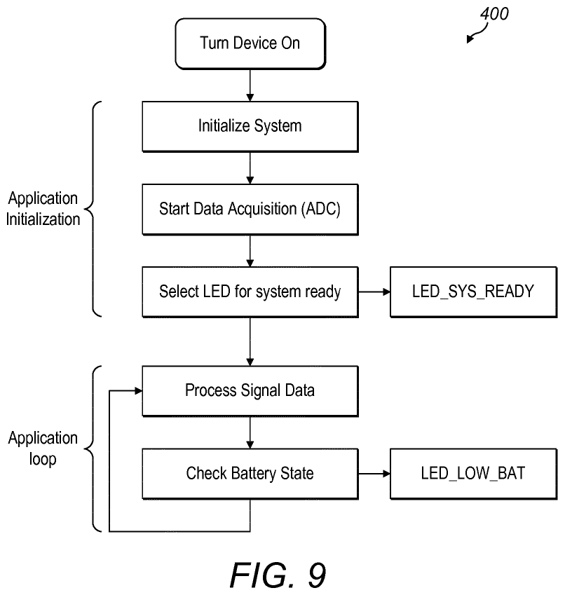

FIG. 9 illustrates a set of method steps 400 that are operated by firmware within the microcontroller 40. This example firmware turns on the device and initialises the apparatus 10 in order to start data acquisition using the ADC 85. Optional LEDs indicate that the apparatus 10 is in a ready state and that signal data are being processed. A loop is achieved to check the battery state of the power function 95 during signal data processing and a low battery indicator LED is shown when the battery is at or below a predetermined level.

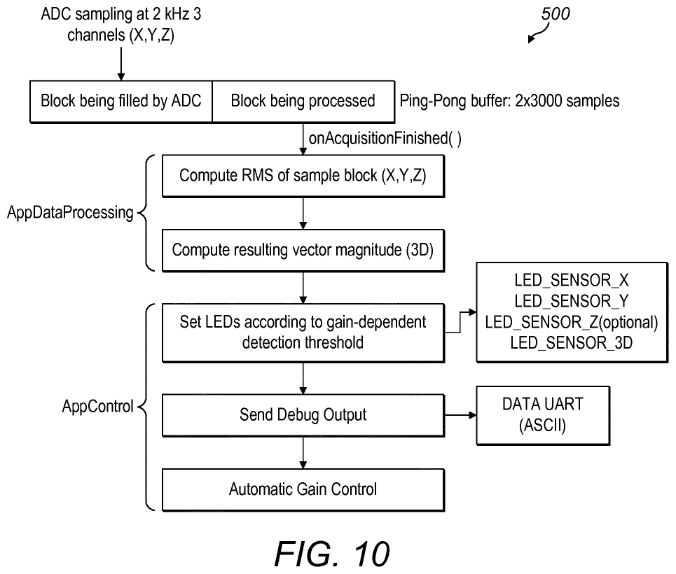

FIG. 10 shows further operational steps achieved by the firmware within the microprocessor 40. Where there are three separate sensing modules 20 (i.e. for 3D analysis) then a vector magnitude in three dimensions is computed based on an RMS sample taken from the ADC 85. Optional LEDs may indicate when a particular amplitude threshold or range for the magnetic flux density is achieved to indicate that the device has detected a powered operational state of the aircraft. Automatic gain control is also included in this routine and debug outputs may be provided, if required. Vector magnitude calculations may divide the 3D value by √3 (ratio diagonal/side), for example.

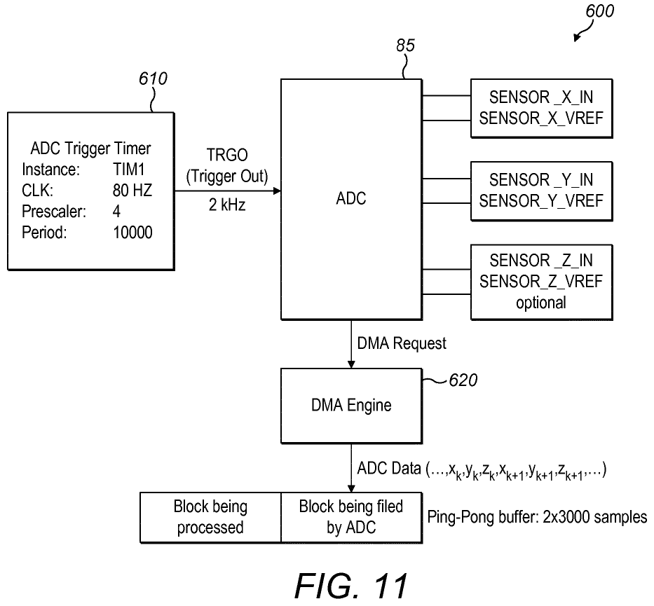

FIG. 11 shows a schematic diagram of a portion of apparatus 10 shown in FIG. 1. In particular, this figure shows in more detail how the ADC 85 interacts with the sensing module(s) 20. The ADC 85 is triggered using an ADC trigger timer 610. In this example, a 2 kHz trigger is used but other frequencies may also be used. The ADC 85 receives analogue values from each of the three sensing modules 20 and the ADC 85 sends these digitalised results to a direct memory access engine 620 which populates blocks of data in a buffer. This provides the averaging functionality described above.

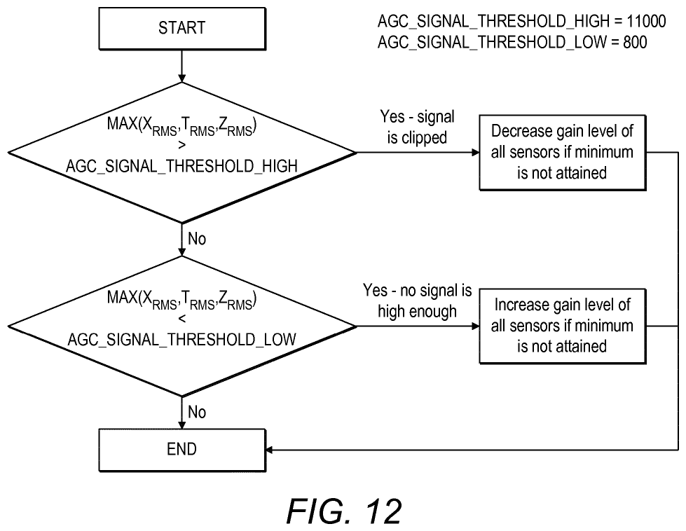

FIG. 12 shows a flowchart illustrating how the PGA 70 is controlled to provide automatic gain control for the system 10. This process increases the gain of the PGA 70 if a minimum signal level is not achieved and reduces the gain if a signal becomes clipped or saturates. Therefore, a high and low threshold for the signal level (magnetic flux density) is monitored. The PGA 70 gain can be set to provide a binary or numerical output above a certain amplitude value (e.g. 9 nT) and below a maximum value (e.g. 9200 nT).

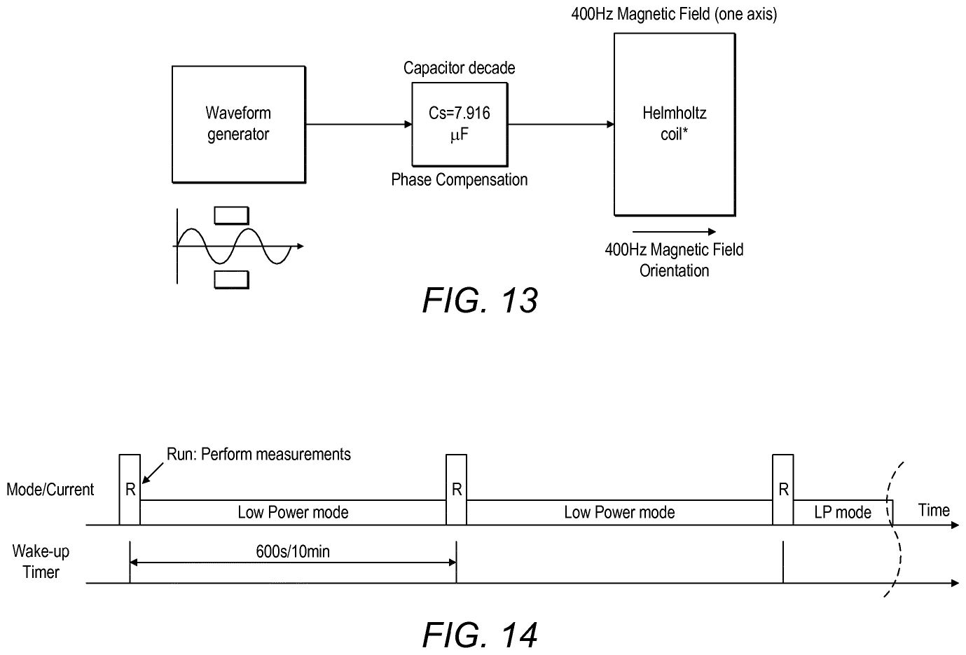

FIG. 13 shows a schematic diagram of a test environment used to test the system 10. The testing environment uses a Helmholtz coil to simulate an alternating magnetic field at 400 Hz. This signal is generated by a waveform generator with phase compensation achieved using a capacitor.

Table 3 shown below shows an example set of results obtained from this testing environment. The current, magnetic field and gain of the programmable gain amplifier 70 are provided at different levels with the raw data being output together with an LED indicating detection at the particular signal levels.

TABLE 3

| Generator | Current | | | | | | | | | | | | |
|---|---|---|---|---|---|---|---|---|---|---|---|---|---|
| amplitude | Amplitude | Magnetic | | TH | TH | Data | Data | Data | Data | LED | LED | LED | LED |
| [mVrms] | [μA] | Field [nT] | Gain | axis | 3D | X | Y | Z | 3D | X | Y | Z | 3D |
| 0.3 | 10 | 10 | 3 | 0 | 3500 | 3320 | 0 | 0 | 3320 | 0 | 0 | 0 | 0 |
| 0.4 | — | 12.5 | 3 | 2575 | 3500 | 4437 | 255 | 0 | 4430 | 1 | 0 | 0 | 1 |
| 0.7 | 30 | 20 | 3 | 4500 | 3500 | 7760 | 478 | 0 | 7770 | 1 | 0 | 0 | 1 |
| 1.35 | — | 41 | 2 | 960 | 350 | 1660 | 0 | 0 | 1660 | 1 | 0 | 0 | 1 |
| 3 | — | 88 | 2 | 1930 | 350 | 3340 | 181 | 0 | 3340 | 1 | 0 | 0 | 1 |
| 5 | 680 | 147 | 2 | 3210 | 350 | 5560 | 313 | 0 | 5560 | 1 | 0 | 0 | 1 |
| 10 | 1360 | 290 | 1 | 627 | 0 | 1101 | 0 | 0 | 1101 | 1 | 0 | 0 | 1 |
| 20 | 2722 | 585 | 1 | 1276 | 0 | 2216 | 0 | 0 | 2216 | 1 | 0 | 0 | 1 |
| 50 | 6855 | 1455 | 1 | 3216 | 0 | 5558 | 3136 | 0 | 5560 | 1 | 0 | 0 | 1 |
| 75 | 10230 | 2180 | 1 | 4780 | 0 | 8260 | 511 | 0 | 8260 | 1 | 0 | 0 | 1 |
| 100 | 13654 | 2900 | 0 | 636 | 0 | 1115 | 0 | 0 | 1115 | 1 | 0 | 0 | 1 |
| 200 | 27302 | 6800 | 0 | 1280 | 0 | 2231 | 0 | 0 | 2231 | 1 | 0 | 0 | 1 |

FIG. 14 shows schematically the timing of measurements and how these are achieved at intervals to reduce overall power consumption. Measurements are taken at the points in time indicated by “R” with a low power mode of around 600 seconds between measurements. A timer is used to control the low power mode when measurements do not take place.

Table 4 shown below illustrates test results for battery life with particular capacity batteries based on a 600 second low power mode. For the larger 1000 mAh battery, a life of 690 days may be achievable under certain conditions.

TABLE 4

| | Typical LP Current | | Total Current 1‰ run | Estimated Battery | Estimated Battery |
|---|---|---|---|---|---|
| Low Power Mode* | @ 25° C. | | @60 mA | life 1000 mAh | life 240 mAh |
| Shutdown RTC 32 kHz | 325 | nA | 60.3 μA | 690 d | 165 d |
| Stop Mode 2 Wake up | 2 | μA | 62.8 μA | 663 d | 160 d |
| with periph. | | | | | |
| Sleep Mode (PLL on) | 0.2 | mA | 260 μA | 160 d | 38 d |

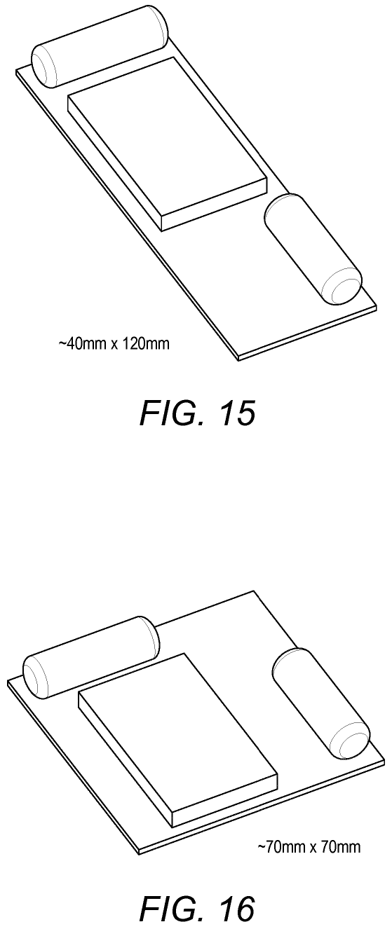

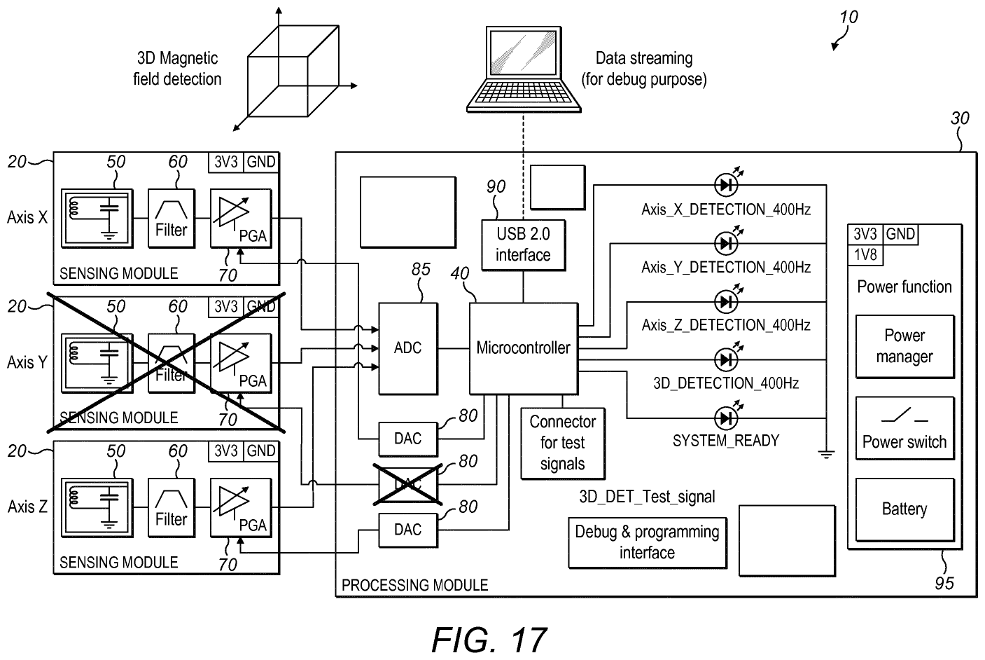

FIGS. 15 and 16 illustrate particular different sensor module layouts and sizes that may be used. In these example layouts, two orthogonal sensing coils are used (for use with the example described below with reference to FIG. 17) rather than three (as may be used with the example of FIG. 1). A third sensing coil may be added, which may be perpendicular to the other two coils.

FIG. 17 shows an alternative embodiment of the apparatus 10. This diagram illustrates schematically similar components to those found in FIG. 1. Only two sensing modules 20 are included in this embodiment so that only measurements on the X and Z axis are possible (rather than the three sensors shown in FIG. 1). However, this removes the need for one of the sensing modules 20 and one of the digital to analogue converters 80 (reducing size and power requirements). Nevertheless, such a configuration provides sufficient measurement results to allow discrimination between an operational and non-operational aircraft. Similar reference numerals indicate similar components of the in this figure.

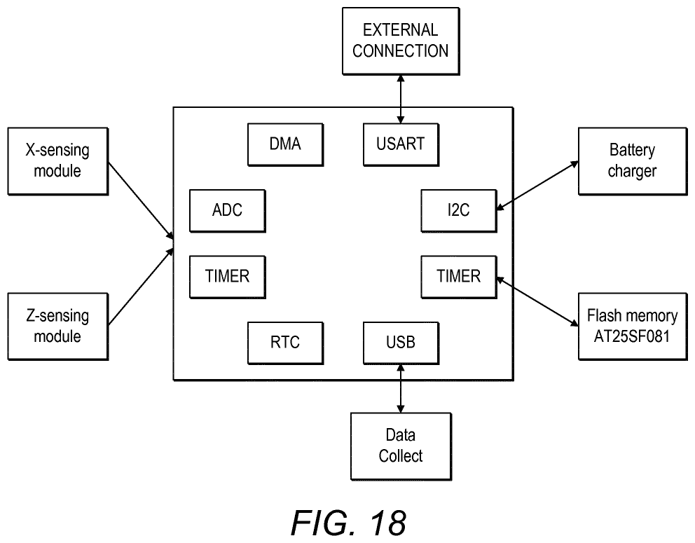

FIG. 18 shows a high-level schematic diagram of this alternative embodiment of the apparatus 10. However, this alternative embodiment operates in a very similar way to that described with reference to the apparatus 10 of FIG. 1.

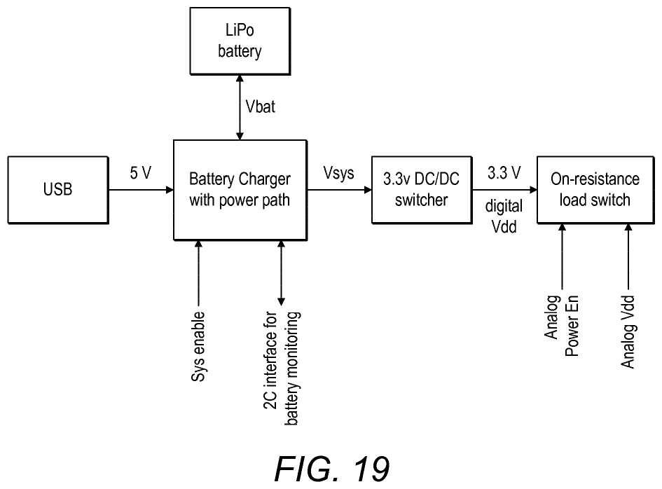

FIG. 19 shows an example power management system that may be used with any embodiment described within this description. The battery may be a lithium polymer battery charged using power derived from the USB interface. A battery charger that both charges and monitors the battery and enables the system to be powered on command or at intervals is illustrated in this figure. A DC to DC switching circuit provides a regulated voltage, which supplies power via a resistance load switching circuit. Other battery types (both primary/non-rechargeable and secondary/rechargeable) may be used.

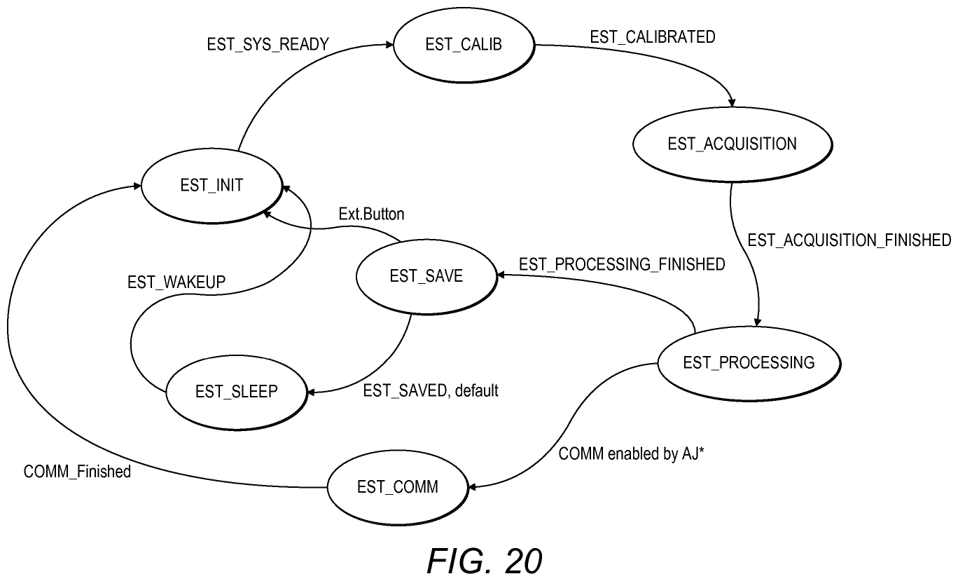

FIG. 20 shows further example use case for operating the apparatus 10 according to any of the embodiments described within this description. This use case includes initiating the apparatus 10, calibrating the system and acquiring data. Once data is acquired, then the data are processed and either saved and/or communicated with the apparatus 10 entering a sleep mode before it is woken up to start the cycle again at apparatus initiation.

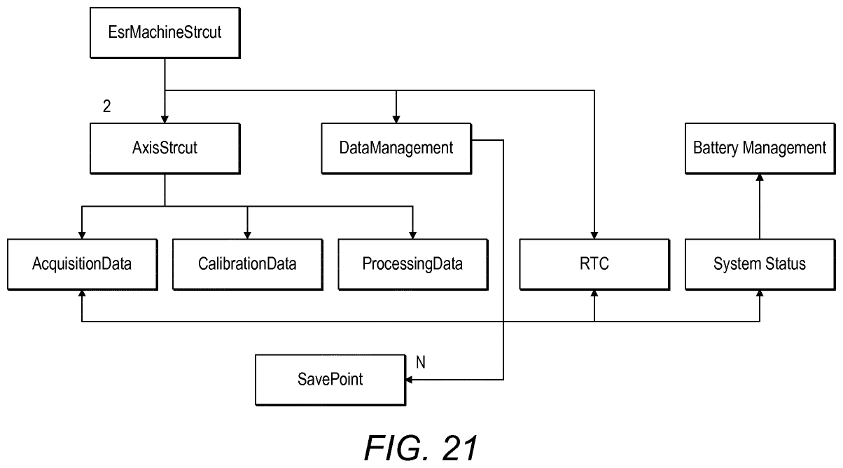

FIG. 21 shows a high-level functional diagram of the firmware used to operate the microcontroller 40. This firmware includes data acquisition, data management, calibration, battery management and system status functions as well as a real-time clock (RTC).

Table 5 shown below illustrates test results from the apparatus 10 taken within an aircraft. These test results illustrate successful detection of the operational status of the aircraft. In this example, boarding commenced 06:35 and in this example the engines were running from 06:40 until 10:19.

As will be appreciated by the skilled person, details of the above embodiment may be varied without departing from the scope of the present invention, as defined by the appended claims.

For example, different dimensions of the coil may be used. The values and signatures of the pressure changes may be different for different aircraft. Capacitors may be used to supply power instead of the battery. A single coil may be used for electromagnetic detections. Separate frequency and magnetic flux density sensors may be used.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method of detecting an operational state of an aircraft, the method comprising the steps of:
conducting passive measurements including:
measuring an electromagnetic frequency at a location;
measuring a magnetic flux density at the location; and
determining that the aircraft is in a powered state when criteria are met, wherein
the criteria include:
the measured electromagnetic frequency is between 370 Hz and 1kHz; and
the measured magnetic flux density is between 9 nT and 9200 nT.

2. The method of claim 1 further comprising the step of changing state of a device when the aircraft is determined to be in the powered state or determined to change to a powered state, wherein the device is an external device or a device integrated with one or more sensors arranged to measure the electromagnetic frequency and/or the magnetic flux density.

3. The method of claim 2, wherein the change of state is a change from a higher power mode to a lower power mode.

4. The method of claim 2, wherein the change of state to the lower power mode turns off any one or more of: a transmitter, a receiver, a sensor, an oscillator, and/or a processor.

5. (canceled)

6. The method of claim 1, wherein the passive measurements further include:
measuring air pressure at the location and wherein the criteria further include the measured air pressure is below 90 kPa; and
measuring air pressure at the location and wherein the criteria further include the measured air pressure increasing by equal to or greater than 780 Pa and then decreasing by equal to or greater than 780 Pa over a period of less than one second.

7. (canceled)

8. The method of claim 1, wherein the passive measurements are conducted at intervals and/or when movement is detected.

9-10. (canceled)

11. The method of claim 1 further comprising the step of:
determining that the aircraft is in a non-powered stated when the criteria are not met.

12. The method of claim 11 further comprising the step of changing state of a device when the aircraft is determined to be in the non-powered state or to change to the non-powered state, wherein the change of state is a change from a lower power mode to a higher power mode, wherein the change of state to the higher power mode turns on any one or more of: a transmitter, a receiver, a sensor, an oscillator, and/or a processor.

13-14. (canceled)

15. An apparatus for detecting an operational state of an aircraft, the apparatus comprising:
one or more sensors configured to:
measure an electromagnetic frequency at a location, and
messure a magnetic flux density at the location, and
one or more processors configured to:
receive data from the one or more sensors, and
determine that an aircraft is in a powered state when criteria are met, wherein the criteria include:
the measured electromagnetic frequency is between 370 Hz and 1kHz, and
the measured magnetic flux density is between 9 nT and 9200 nT.

16. The apparatus of claim 15, wherein the one or more processors are further configured to change a state of a device when the aircraft is determined to be in a powered state or determined to change to a powered state, wherein the change of state is a change from a higher power mode to a lower power mode.

17-18. (canceled)

19. The apparatus of claim 16, wherein the device is an external device to the apparatus, the apparatus further comprising an interface to the device, wherein the interface is a wired or wireless interface.

20. (canceled)

21. The apparatus of claim 15, wherein the one or more sensors are further configured to measure air pressure at the location and the criteria further include:
the measured air pressure is below 90 kPa;
the measured air pressure increasing by equal to or greater than 780 Pa and then decreasing by equal to or greater than 780 Pa over a period of less than one second; and/or
the measured air pressure indicating a rise in altitude of above 3 m in less than 60 s.

22. The apparatus of claim 21, further comprising a centred moving average filter configured to filter a signal received from the air pressure sensor.

23. The apparatus of claim 15 further comprising an accelerometer, wherein the one or more processors is further configured to:
determine an orientation of the apparatus based on signals received from the accelerometer.

24. The apparatus according to claim 23 further comprising a centred moving average filter configured to filter a signal received from the accelerometer.

25. The apparatus of claim 22, wherein the moving average filter(s) is/are further configured to perform a calibration over a time period.

26. (canceled)

27. The apparatus of claim 15, wherein the one or more sensors include:
a coil;
an accelerometer;
and a pressure sensor
wherein the one or more processors is further configured to power the remaining sensor or sensors when the accelerometer detects movement.

28. (canceled)

29. The apparatus of claim 15 further comprising:
a band pass filter configured to pass 370 Hz to 1kHz; and
a programmable gain amplifier, PGA, in series with the band pass filter, wherein the PGA is configured to increase gain when an electromagnetic frequency of between 370 Hz and 1kHz is detected and, wherein the PGA is configured to increase gain at intervals.

30-32. (canceled)

33. The apparatus of claim 16, further comprising an analogue to digital converter, ADC, configured to receive an input from the PGA and to provide a digital output signal corresponding to the received input, wherein the one or more sensors are further configured to measure the electromagnetic frequency and magnetic flux density at the location in one, two or three orthogonal dimensions.

34-36. (canceled)

37. One or more non-transitory computer-readable media storing computer-executable instructions that, when executed, cause at least one computing device to:
conduct passive measurements including:
measure an electromagnetic frequency at a location;
measure a magnetic flux density at the location; and
determine that the aircraft is in a powered state when criteria are met, wherein the criteria include:
the measured electromagnetic frequency is between 370 Hz and 1kHz; and
the measured magnetic flux density is between 9 nT and 9200 nT.
